(19) United States
(12) Patent Application Publication
(10) Pub. No.: US 2006/0038069 A1
(43) Pub. Date: Feb. 23, 2006

(54) Multi-level vehicle storage facility

(75) Inventor: Richard A. Cawley, Sherborn, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Rectrix Aerodrome Centers, Inc., Hyannis, MA (US)

(21) Appl. No.: 11/185,537

(22) Filed: Jul. 20, 2005

Related U.S. Application Data
(60) Provisional application No. 60/589,715, filed on Jul. 21, 2004.

(51) Int. Cl. B64F 1/00

(52) U.S. Cl. 244/114 R

(57) ABSTRACT

A multi-level vehicle storage facility includes at least one first level storage area, at least one elevated second level aircraft hangar configured for storing aircraft, and a ramp having a grade level entrance and operatively connected to the at least one elevated second level aircraft hangar for moving aircraft to the at least one second level aircraft hangar.

### RELATED APPLICATIONS

The present application claims priority to U.S. Provisional Application Ser. No. 60/589,715, filed on Jul. 21, 2004, and titled “Multi-Level Vehicle Storage Facility.” The contents of this priority application are incorporated by reference herein.

### FIELD OF THE INVENTION

The invention relates generally to a building or structure capable of storing vehicles on at least two different levels. More particularly, the invention relates to a multi-level aircraft hangar having an integral ramp.

### BACKGROUND OF THE INVENTION

Indoor storage and maintenance of aircraft has long required large dedicated buildings (“hangars”) located at airports in a location that is accessible to the runways and/or taxiways, but that is also convenient for pilots, maintenance crews, and others who need to access stored aircraft. Hangar buildings must typically be quite large so as to (1) store aircraft that can take up significant amounts of space due to their size and wingspan, and (2) provide adequate clearance for maneuvering aircraft into, out of, and within the hangar. In large airports with significant amounts of real estate, large hangar buildings can be created as needed to address these needs.

Over time, as air traffic has generally increased, demands on real estate within airports have become more significant, and more efficient storage of aircraft has become a significant issue. This need is even more acute at smaller “regional” airports, often located in small cities or suburbs, which have seen significant increases in usage as major airports have become more crowded and busy. Often these smaller regional airports have very limited ability to grow.

A number of approaches have been taken in an attempt to improve utilization of real estate on airport sites, and of hangar buildings. For example, a number of aircraft hangars have been designed so as to store planes with their tails towards the center of the building, thereby maximizing the number of planes that can be stored in a particular area. A number of these hangars are circular, some even having a “lazy susan” design, rotating the floor so as to place a particular aircraft at the hangar door without having to rearrange the stored planes. Such designs can be seen in U.S. Pat. Nos. 2,964,144; 3,079,871; 3,670,464; 4,697,392; and 6,155,003. These designs, while providing some increased usage of space, are suitable for only a small number of planes, and are not suitable for most real world airport situations in which a number of entities each need dedicated hangar space, and where the buildings must serve multiple purposes within the airport.

Still others have approached the above-described problems by trying to build vertically. U.S. Pat. No. 3,556,441 discloses a multilevel airport building structure having a landing strip on the roof. An aircraft and passenger service area is provided on an intermediate level, and a takeoff strip is provided on a lower level where the aircraft taxies and takes off. A hydraulic aircraft elevator operates in a manner similar to elevators found on aircraft carriers to raise or lower aircraft between levels. While, again, this design can save space in airports, aircraft elevators have proven impractical for general aviation facilities.

Another approach to vertical use of space is illustrated in U.S. Pat. No. 3,954,197. There, pallets are provided on which aircraft can be placed, and support frames are used so that a pallet, with an aircraft on it, can be lifted and placed on top of a support frame. The support frame is designed so that an aircraft can be parked below the frame while the frame holds a pallet and aircraft above. In this way, aircraft can be “stacked” within the hangar. While this approach does save space, it can only be used with small aircraft and it fails to solve a number of the issues facing the use of airport space described above.

Still another design provides an aircraft terminal/hangar facility having passenger and hangar areas located in the same building such that the two areas are separate but adjoining and transverse with respect to each other (U.S. Pat. No. 6,279,855). This design, however, does not increase the number of aircraft that can be stored.

While a number of new designs for airport buildings have been proposed, new designs that efficiently store aircraft are needed to help to reduce airport crowding.

### SUMMARY OF THE INVENTION

The invention involves the use of multiple levels to store vehicles. In one embodiment, the invention includes a first level storage area and a second level storage area. The second level storage area may be elevated with respect to the first level, and a ramp may be provided to provide vehicle access to the elevated second level. Further, the first level storage area can include one or more first level hangar areas that extend below the second level storage area and below a portion of the ramp. The second level storage area can include a vehicle maneuvering deck adjacent to the ramp and one or more second level hangar areas. The features of the ramp and storage areas can be specifically configured for use by aircraft.

### BRIEF DESCRIPTION OF THE FIGURES

FIG. 1 is a site plan for a site having a multi-level vehicle storage facility of the invention;

FIG. 2 is a first level plan for the facility of FIG. 1;

FIG. 3 is a second level plan for the facility of FIG. 1;

FIG. 4 is a sectional elevation view taken along line 4-4 in FIGS. 2 and 3; and

FIG. 5 is an elevation view of the facility of FIG. 1.

### DETAILED DESCRIPTION OF THE INVENTION

The present invention provides a multi-level vehicle storage facility that can be used to store aircraft. The multi-level storage is enabled by the use of a ramp to move a vehicle to a storage level other than “the ground floor.” The following description provides one embodiment of a facility of the invention. This embodiment includes a first aircraft hangar, two smaller aircraft hangars, an automobile parking lot, and office and other storage space on a first level provided at grade. A ramp operatively connects the first level to a second level having an aircraft maneuvering deck and two additional hangars. A person of ordinary skill in the art will recognize that other combinations of hangar and/or parking or other space can be provided within the spirit of the invention, and that more or different levels of the facility could be provided.

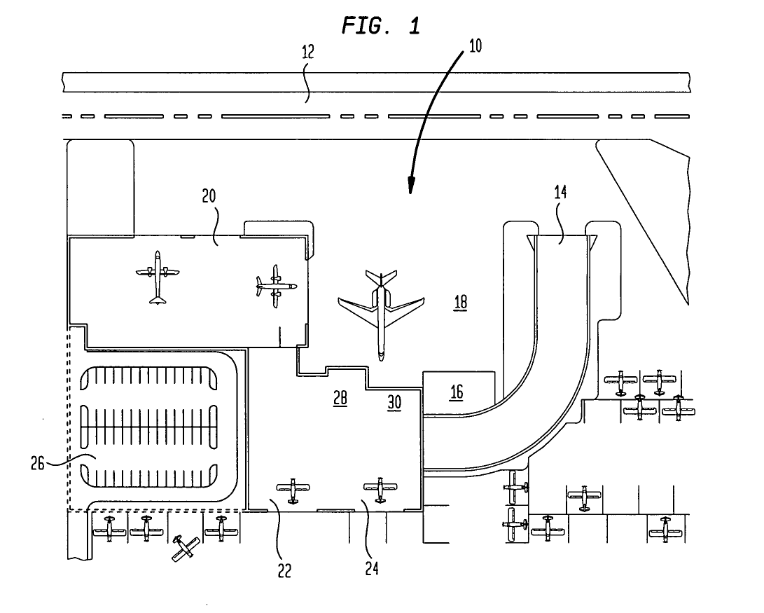

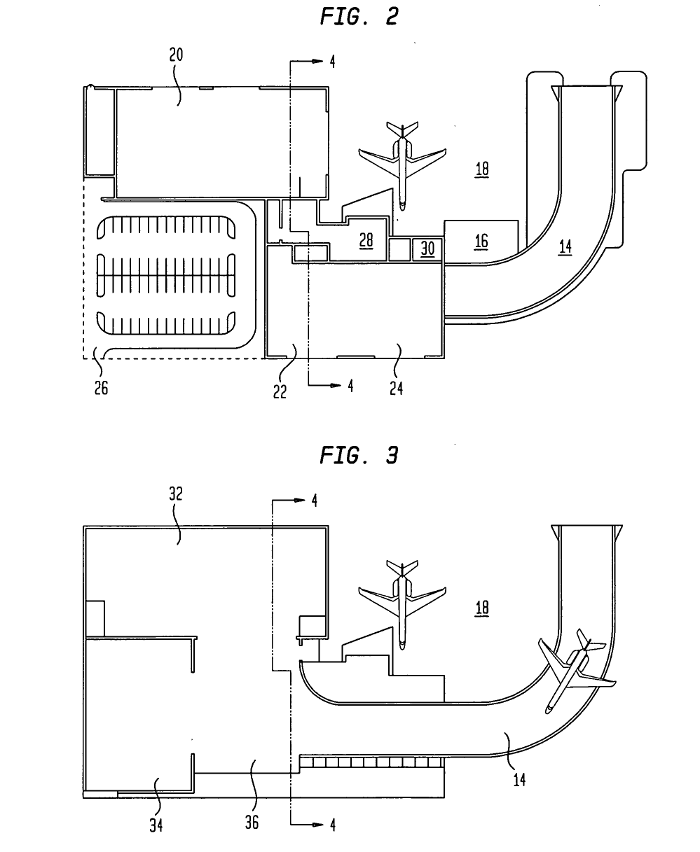

A site plan showing the use of a first, ground or grade level of one embodiment of a facility 10 of the invention is provided in FIG. 1, along with a more detailed first level plan provided in FIG. 2. Facility 10 is provided adjacent to a taxiway or runway 12 that can be used by aircraft to approach the facility. A ramp 14 is provided generally facing the taxiway so that aircraft may readily maneuver onto the ramp. Only a portion of ramp 14 is shown in FIG. 1, with the remaining portion appearing in other figures that illustrate a second level of the facility. As can be seen in FIG. 1, a number of aircraft can be stored outside of the facility 10 and around ramp 14.

Ramp 14 has a number of features making it well suited to moving aircraft to the second level of facility 10. Ramp 14 must provide a minimum rise so as to reach the second level, which must have an elevation sufficient to allow the storage of vehicles, and in particular, aircraft, in the first level below. The incline of the ramp must be low enough to allow aircraft of a desired type to be able to travel the ramp under their own power or by being towed as desired. In one embodiment, the incline of the ramp is less than or equal to about 10 degrees. The ramp must also have a sufficient width to support the movement of selected aircraft and also provide clearance about the ramp sufficient to allow for the aircraft's wingspan. In a specific embodiment, aircraft ramp 14 rises 25 feet above grade across a 460 foot distance. The resulting 5.2% incline can be traveled by Gulfstream V type aircraft or smaller, either under their own power or by tug. The ramp can have a 60 foot width, also based on the requirements of a Gulfstream V, with an additional 30 feet of wingtip clearance on either side provided across the full length of the ramp.

Ramp 14 also curves through an arc of 90 degrees. While the desire to curve ramp 14, and the amount by which to curve it, may depend upon a specific site, in this embodiment, the illustrated configuration provides for a compact foot print for the facility while allowing the ramp to face the taxiway, have the desired length in order to meet incline design requirements, and provide for maneuverability around the ramp on the site so that aircraft may readily approach the facility on a side opposite to the taxiway—thereby allowing greater access to the facility. In addition, the curve in ramp 14 provides a convenient and safe location for fuel farm 16 and aircraft apron 18.

As can be seen in the embodiment of FIGS. 1 and 2, the overall layout of the hangar building, ramp and aircraft apron is generally (though not perfectly) rectangular, with a longitudinal axis of the rectangle (an axis generally centered on the layout's longer dimension) generally parallel to the taxiway. The ramp begins at grade level generally perpendicular to, and somewhat proximate to, the taxiway (and thus generally perpendicular to the longitudinal axis of the layout). The ramp then turns approximately 90 degrees and approaches the hangar facilities in a direction that is generally parallel to the longitudinal axis of the facility and generally parallel to the taxiway. While other configurations can be employed within the spirit of the invention (the longitudinal axis of the layout could, for example, be angled with respect to the taxiway so as to fit within an irregularly shaped site), this configuration provides certain advantages as noted above.

A number of separate aircraft hangar, airport operational facilities, and other storage/operation areas are provided on the first level of facility 10. Hangar One 20 is provided on level one with access for aircraft from the taxiway and from the aircraft apron. In an exemplary embodiment, this hangar provides 31,200 square feet of storage and 18 feet of clearance. Two smaller first level hangars 22, 24, such as might be used by flight schools or other small aircraft operators, are provided at least partially below ramp 14. In the illustrated embodiment, the small hangar 24 on the right is provided beneath the ramp, while the small hangar 22 is provided partially beneath the ramp. These hangars are accessible from a side of the facility opposite from the taxiway.

A parking lot/automobile access road 26 can also be provided on the first level as part of facility 10. A Fixed Base Operator (FBO) or other ground facilities 28 can also be provided, preferably accessible from the parking lot/automobile access road, as well as other storage and mechanical facilities 30.

Turning now to the second level plan illustrated in FIG. 3, second 32 and third 34 hangars are provided. Hangar Two 32, located directly above Hangar One 20, has, in the illustrated configuration, the same 31,200 square feet of storage space as Hangar One, but provides greater clearance to underside of structure (28 feet can be used to accommodate Gulfstream V type aircraft). Where multiple hangars are provided on the second level, it can be advantageous to provide a level maneuvering deck 36, allowing aircraft to maneuver easily to either of adjacent Hangars Two and Three.

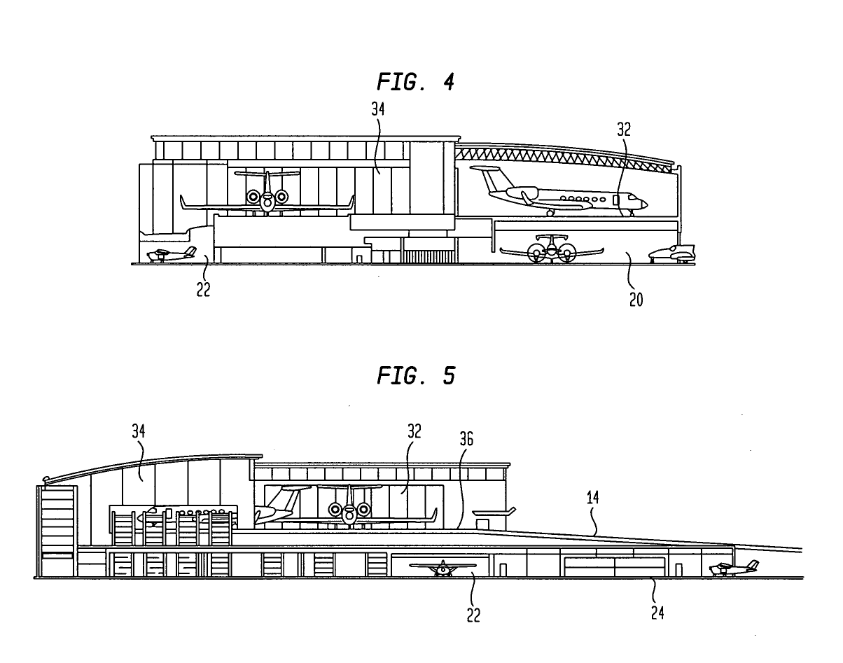

As can be seen from FIGS. 1 to 3, as well as from the elevation views provided in FIGS. 4 and 5, facility 10 of the invention results in significantly improved use of airport real estate. Hangar Two 32 can be provided above Hangar One 20. Hangar Three is provided above parking lot 26. Maneuvering deck 36 is provided above parking lot 26 and a portion of smaller hangar 22. Smaller hangar 24 and a portion of smaller hangar 22 are provided below the ramp 14. This exemplary combination of vehicular storage has been designed so as to increase aircraft hangar capacity in a location with limited available land area. The expected aircraft hangar square footage was increased by 50% through the design of a two-level hangar facility, incorporating a low-slope aircraft ramp and second level aircraft maneuvering area accessing second level hangar space.

Due to their size and load carrying requirements, the hangars can generally be constructed using a precast concrete structure for both the vertical structural columns/beams/bracing and the second level floor decking and structural members. Hangar wall systems can be insulated metal panel wall infill combined with translucent panels and glazing. The roof can be constructed of steel truss members supporting a membrane roofing system on a vaulted deck, or in other manners that might be specified by the appropriate building codes. The aircraft ramp can be a precast concrete structure: a cast-in-place concrete slab can be poured on an earthen base between precast concrete retaining walls for the lower portions of the ramp, and a precast concrete frame and decking supporting a cast-in-place concrete topping at the upper portions of the ramp and deck. The structured nature of the upper portion of the aircraft ramp and maneuvering deck allows for efficient use of the area below for flight school hangars, protected automobile parking, and protected client pick-up/drop-off at the FBO lobby entrance.

While the elevation views provided above show a ramp that begins at a grade level that is approximately even with the first level, a person of ordinary skill in the art will recognize that the ramp could begin at a higher or lower level depending on the local grade in the region of the ramp. For example, the ramp might begin at a grading that is higher than the first level, allowing the ramp to maintain a desired incline in a shorter distance than would otherwise be achieved. In such a circumstance, the grading might provide a further “ramp” down to the first level from the start of the ramp to the second level.

Still further, the ramp depicted above is build so as to rise above the grade around the hangar facility. It is possible, however, to build the ramp into a grade around the hangar facility so that aircraft could enter the hangars on the second level from one side of the facility, while they could also enter the first level hangars from a second side of the facility. In this circumstance, the ramp would be built into the grade, or graded, rather than being built above grade level. Such a graded ramp providing access between hangars provided one on top of the other would fall within the spirit of the present invention.

A person of ordinary skill in the art will appreciate further features and advantages of the invention based on the above-described embodiments. For example, specific features from any of the embodiments described above as well as in the attached Figures may be incorporated into the invention in a variety of combinations and subcombinations. Accordingly, the invention is not to be limited by what has been particularly shown and described, except as indicated by the appended claims or those ultimately provided.

1. A multi-level vehicle storage facility comprising:
at least one first level storage area at least one elevated second level aircraft hangar configured for storing aircraft; and
a ramp having a grade level entrance and operatively connected to the at least one elevated second level aircraft hangar for moving aircraft to the at least one second level aircraft hangar.

2. The facility of claim 1, wherein the ramp has an incline of less than about 10 degrees.

3. The facility of claim 2, wherein the ramp has an incline of less than or equal to about 5.2 degrees.

4. The facility of claim 2, wherein the ramp is configured to have a grade level entrance oriented substantially perpendicular to a taxiway or runway.

5. The facility of claim 2, wherein the ramp includes a curve.

6. The facility of claim 5, wherein the ramp includes a curve of approximately 90 degrees.

7. The facility of claim 6, wherein the first level storage area includes at least one aircraft hangar, and the facility further includes an aircraft apron that is located between the at least one aircraft hangar and a grade level entrance to the ramp.

8. The facility of claim 6, wherein the facility is provided on a generally rectangular foot print.

9. The facility of claim 8, wherein the facility is proximate to a taxiway, and a longitudinal axis though the generally rectangular foot print is substantially parallel to the taxiway.

10. The facility of claim 1, wherein the facility comprises a plurality of second level aircraft hangars.

11. The facility of claim 10, further comprising a second level maneuvering deck for maneuvering an aircraft from the ramp into a selected second level aircraft hangar.

12. The facility of claim 1, wherein the first level storage area includes at least one first level aircraft hangar that extends below the at least one second level aircraft hangar.

13. The facility of claim 1, wherein the first level storage area includes at least one first level aircraft hangar that extends and below at least a portion of the ramp.

14. The facility of claim 1, wherein the first level storage area includes a parking lot configured for storage of automobiles.

15. A multi-level aircraft storage facility comprising:
at least one first level aircraft hangar configured for storing aircraft;
at least one elevated second level aircraft hangar configured for storing aircraft, the second level aircraft hangar being at least partially located above the first level aircraft hangar; and
a ramp operatively connected to the at least one elevated second level aircraft hangar for moving aircraft to the at least one second level aircraft hangar.

16. The facility of claim 15, wherein the ramp is at least partially built above grade level.

17. The facility of claim 16, wherein the ramp is a graded ramp.
